(19) United States
(12) Patent Application Publication
(10) Pub. No.: US 2008/0204253 A1
(43) Pub. Date: Aug. 28, 2008

(54) Pest Monitoring System

(76) Inventors: Peter Karl Cottee, Wirral (GB); Mark Lees, Cheshire (GB); Paul Roy Gorton, Manchester (GB)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/065,538

(22) PCT Filed: Aug. 21, 2006
(86) PCT No.: PCT/GB06/03138

§ 371 Date: Apr. 4, 2008

(30) Foreign Application Priority Data
Sep. 3, 2005 (GB) 0517917.1

(51) Int. Cl. G08B 23/00; A01M 23/24; A01M 23/30; A01M 31/00

(52) U.S. Cl. 340/573.2; 43/82

(57) ABSTRACT

A system (100) for monitoring the presence and activity of rodents and other pests comprising a base station (120) and a plurality of remote stations (11) which may be installed at positions around the premises to be monitored. Each remote station comprises a baited housing through which a rodent would pass. If a trap (20) is actuated it causes a signal to be transmitted to a base station (120) which in turn transmits an SMS message to a cellular telephone network (140). The system will determine which of the remote stations has been activated and will provide data as to the manner of activation. The system enables operators to monitor pest activity in premises such as food manufacturing facilities in order to control the presence and activity of such pests without the need for regular and frequent inspections of the remote stations.

### TECHNICAL FIELD

This invention concerns a system comprising:

i) A plurality of remote stations each comprising a bait box containing either a trap or a monitoring means, a transmitter unit, microprocessor and a power source;

ii) A base station comprising a receiver, microprocessor and transmitter, and

iii) Optionally one or more repeaters.

The system may further utilise a range finder when being installed and the base station will most preferably communicate with e.g. a mobile phone system via SMS text messaging.

It also concerns a method for monitoring the presence and activity (status) of live objects such as rodents or other pests, including insects using the system and an improved bait box and remote station for use in the system. Such a system may be operated, for example, at a food manufacturing or distribution site where the presence of pests may be critical to the operation of such a site and where such presence and activity must be monitored and recorded. The system may be installed at such a site and monitored by a remotely located organisation.

### BACKGROUND OF THE INVENTION

Traditionally, the presence and activity of, for example, rodents have been monitored by the placement of traps which may entrap a rodent or may simply transmit a signal when a rodent passes through the trap, usually taking bait from the trap which will ultimately cause the death of the rodent.

There is a hygiene requirement in many establishments requiring the presence of such pests to be recorded in a manner which will enable operatives to eradicate the problem.

A number of prior art systems are known and these are identified below:

US2005/0097808 (Vorhies) describes a tube-type trap system for the humane, non injurious, non invasive trapping of animals and to methods and systems for electronic remote trap monitoring and management. Computer systems at a remote home base permit simultaneous management of multiple traps in the field, including management via the internet. The trap data communication and management system includes data encoders, transmitters and/or transceivers, computer programs and related equipment to enable activation, coding and use of the data communication system, including data display and management and operation report generation. The remote monitoring from a single home base enables each trap to be serviced when tripped, based on the status alert radioed to a home base from each trap when that event occurs.

WO 2004/021735 (Cesco) describes a remote monitoring system for exterminating pests comprising at least one sensor, installed at a plurality of zones of a subject site, for sensing movement of the pests in the zones, and producing and transmitting detection signals corresponding to the movement; at least one remote controller, installed at the subject site, for receiving the detection signals and processing and transmitting the received detection signals; and a central control apparatus for receiving information from at least one remote controller, analyzing the information and managing the analyzed information by zones. In a second embodiment the central control apparatus retransmits the analysis results of the pest related information to a user of each building or a service technician. The later may receive the information on a PDA or a mobile phone.

US2003/166999 (Trompen) describes a pest control system for the detection of pest such as termites. The communication arrangement transmits a wireless signal indicative of the operation of the monitoring device for reception at one or more off site locations.

WO2004/110142 (Ronnau Development Aps) describes an integrated method and system for preventing and solving problems relating to pests.

JP 2004057147 (Garagaa Eiji K K) discloses a monitoring system for trapped animals comprising a plurality of traps and an information management centre which receives information signals transmitted from the traps through a phone line.

EP115280 (Dow AgroScienceLLC) discloses a pest control system including a number of pest control devices and an interrogator to gather data from the pest control devices. The interrogator may be in a hand held form configured to individually establish wireless communication with each of the pest control devices.

Each of the above systems has limitations and the present invention offers advantages over each of the above systems. In particular the system of the present invention is particularly suited for managing trap based systems where animals are killed in that it is able to distinguish whether a trap has caught an animal or merely been triggered. The system is a simple, low cost system, which is robust, and is programmed in a manner which reduces the reporting of false positives and negatives and saves battery life and reporting/management costs.

In addition it provides for an improved bait box which allows for the simple insertion of e.g. a break back trap in a manner enabling improved and more robust signalling through its integration in conjunction with a microprocessor.

### SUMMARY OF THE INVENTION

The present invention relates to a system for monitoring the presence and activity of live objects such as rodents or other pests, comprising a base station and at least one remote station; the or each remote station comprising sensing means to detect the presence of a live object and to produce a signal representative thereof, and a transmitter responsive to said signal and adapted to transmit a signal accordingly to the base station; the base station comprising a signal receiver and an SMS message transmitter adapted upon receipt of a signal from the or one of the remote stations, to generate and transmit an SMS message to a cellular telephone network.

According to a first aspect of the present invention there, is provided a system (100) for monitoring and reporting upon the presence and/ or activity of live objects such as rodents or other pests, comprising:
a. a plurality of remote stations (110);
b. a base station (120); and
c. optionally one or more repeaters (130)

wherein

the at least one remote station (110) comprises:
i) a sensing means (38,42,44,46) to detect the presence and/or activity of the live objects;
ii) a microprocessor (40) programmed to communicate with the sensing means;
iii) inputs linking the sensing means with the microprocessor; and
iv) a signal transmitter (50) adapted to transmit a signal to the base station;

and the base station (120) comprises:
i) a signal receiver (64);
ii) a microprocessor (66) programmed to analyse and communicate information received; and
iii) a message transmitter (68) for transmitting selected information to a cellular telephone (140) or computer.

Preferably the message transmitter is a GSM module and can transmit SMS text message to one or more phones and/or computers.

In a preferred embodiment, which employs a trap, the sensing means are a series of contacts. However, in alternative embodiments, which may not employ a trap, the sensing means may be a micro-switch actuated by a live object passing through an enclosed passage. Thus the sensors may be responsive to the size or weight of the live object. Alternatively visual monitoring and sensing means may be utilised e.g. infra-red detectors.

The remote stations may be baited and/or include poison.

In a preferred embodiment of the invention the remote stations' microprocessor is programmed to spend the majority of its' time in a dormant state and wake periodically to check the stations status. Preferably the microprocessor wakes for less than 1.5 seconds every 5 seconds. This enhances battery life in the field.

In another preferred embodiment the remote stations' microprocessor is programmed to report only verified signals. A verified signal is one which has been received twice in a given time period. Preferably, the time period is only a few seconds. More preferably still the system is programmed to stop processing signals for a given time period after a verified signal has been received and or transmitted. This given time period is from 5-15 minutes. This dual action significantly improves the reliability of signalling.

Preferably the remote stations transmit information selected from the group consisting of:
A remote unit number (code);
A remote unit group (a number of discrete units may be grouped by, for example locality);
A signal type (in the case of a break back trap: trap set, trap sprung or dead body); and
A check digit (allowing accurate auditing of data).

Preferably the remote stations' microprocessor is programmed to repeatedly send a signal for a period of between 5 and 15 minutes to ensure it is received at the base station.

Preferably the remote stations' microprocessor is programmed to periodically, throughout a day, check that signals are being received and signal this to the base station. Preferably at least three checks are made in a 24 hour period.

Preferably the reporting signal includes:
A remote unit number;
A remote unit group;
An OK Signal; and
A check digit.

The microprocessor of the base station is also programmed to improve data control. The base stations' microprocessor is programmed with information selected from the group consisting of
A user access code;
A customer name;
A customer reference number;
A customer post code;
The number of remote units on the system;
A base unit zone reference;
One or a plurality of level one phone numbers; and
One or a plurality of level two phone numbers.

Preferably the base stations' microprocessor is programmed to avoid duplication of messages. Thus on receipt of a signal by the receiver, the unit waits for a first set period before re-checking the signal and only if the signal is the same will it decode it, verify it and send an activity message whilst simultaneously ignoring further signals from the remote unit for a second set period. The first set period is from 30 seconds to 5 minutes and the second set period is from 5 to 30 minutes.

Preferably the base stations' microprocessor is programmed to pass instructions to a GSM module to send an SMS message to selected stored numbers.

Preferably the base stations' microprocessor is programmed to interrogate it's memory and pass a status report to the transmitter for sending.

Preferably the GSM unit is programmed to attempt to communicate with the base unit's microprocessor on a regular basis and in the event it can't get a response to initiate a base reset.

According to a further aspect of the present invention there is provided a method of monitoring the presence and activity of live objects such as rodents or other pests, comprising the steps of providing a base station (120) and one or more remote stations (110), the or each remote station having signal transmitting capability (50), and the base station having SMS message transmitting capability (68), causing the or each remote station to transmit a signal upon detection of the presence of a monitored live object and causing the base station to receive such signal and in turn to transmit an appropriate SMS message to a cellular telephone network (140).

According to yet a further aspect of the present invention there is provided a bait box (10) for a break back trap (20) comprising a trap housing (28) having associated therewith three contacts (38, 42, 44) which when a trap is fitted thereto can, when linked to a microprocessor, send a signal indicating the trap is either set, sprang or contains a body.

Preferably the bait box comprises a centre spring contact which contacts a setting arm of a trap and contacts at either side thereof which contact the break back arm of the trap in respectively its set or sprung position.

Preferably a trap set contact is shaped and arranged to exert a slight downward force on the break back arm in its set position.

According to yet a firer aspect of the invention there is provided a remote station (110) comprising a bait box (10) of the invention together with a trap (20), power source (30), microprocessor (40) and transmitter (50).

### BRIEF DESCRIPTION OF THE DRAWINGS

A preferred embodiment of the invention will now be described, by way of example only, with reference to the accompanying drawings, in which:

FIG. 1 is a schematic illustration of a system in accordance with the invention;

FIG. 2 is a preferred remote station of the invention;

FIG. 3 is a preferred bait box of the invention with a trap shown displaced therefrom;

FIG. 4 is the preferred bait box of the invention with the trap shown in the trap set position;

FIG. 5 is the preferred bait box of the invention with the trap shown in the trap sprung position; and

FIG. 6 is the preferred bait box of the invention with the trap shown in the dead body position.

### DESCRIPTION OF EXAMPLE EMBODIMENTS

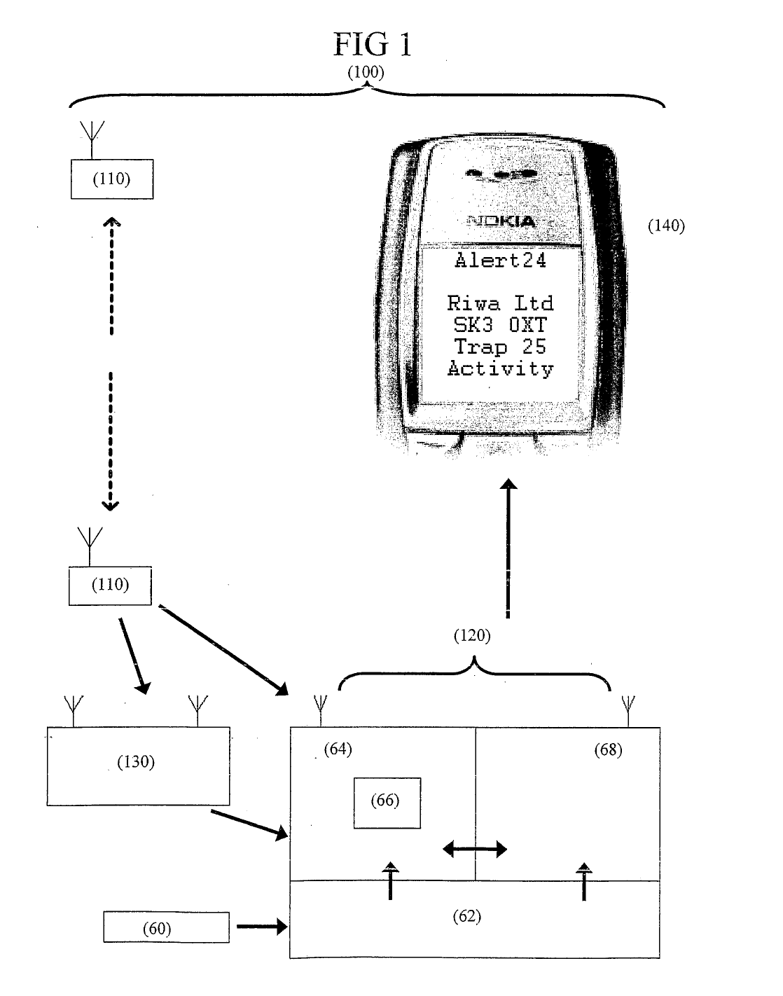

FIG. 1 is a schematic showing the system components in outline together with the components of the base station. The system (100) comprises a plurality of remote stations (110) which detect pest activity and signal their findings to a base station (120) directly or via one or more repeaters (130). The base station decodes the signals and controls the messages sent out to a cellular phone (140) and/or computer.

As is illustrated in FIG. 1, the base station (120) plugs into a mains supply (60), which via a voltage regulator (62) present in the base station provides power, and comprises a RF receiver (64) a microprocessor (66) and a transmitter in the form of a GSM module (68). The receiver/microprocessor section monitors, decodes and identifies the incoming transmissions from the rodent traps and communicates with the GSM module. The GSM module controls and prioritises SMS messages sent out through the GSM module. Several destinations can be programmed in together with the type of information which will trigger a message. Both the above sections are powered by the voltage regulator section (62) which plugs into the mains supply via a “plug top” PSU.

The remote station (110) can merely monitor pest activity or can be used in conjunction with a trap or poison. There can be up to a hundred or more rodent traps each individually encoded to send out alarm status signals via a radio link to the base station either directly or via one or more RF repeaters (130).

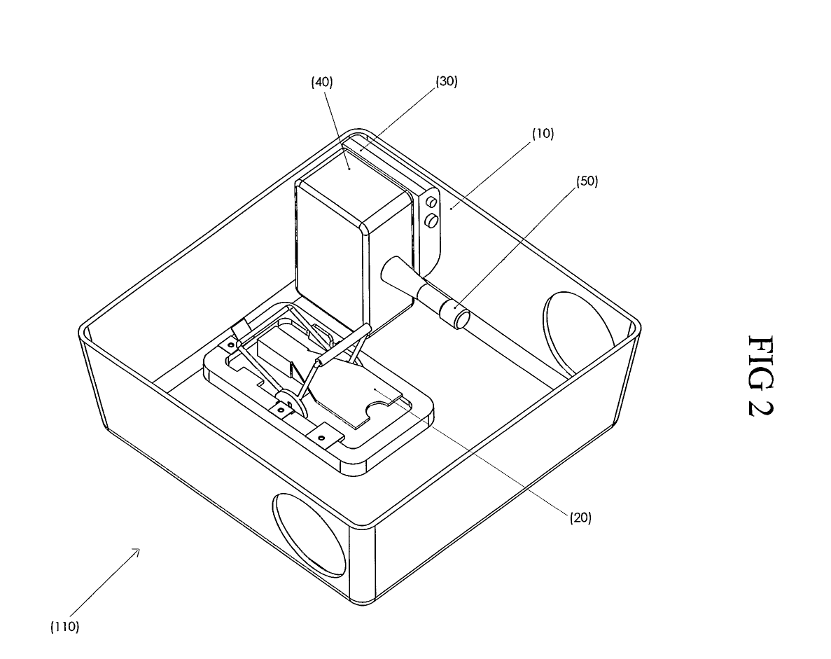

In addition to the base station (120) the other essential components of the system are the remote stations (110). FIG. 2, illustrates a preferred form of remote station (110). It shows a bait box (10) with a trap (20), battery pack (30), microprocessor (40) and transmitter (50) in place. The bait box, which is shown open for clarity, has a hinged lid (not shown) which can be shut and locked to secure the contents therein. This is particularly important if poisons are used in the box.

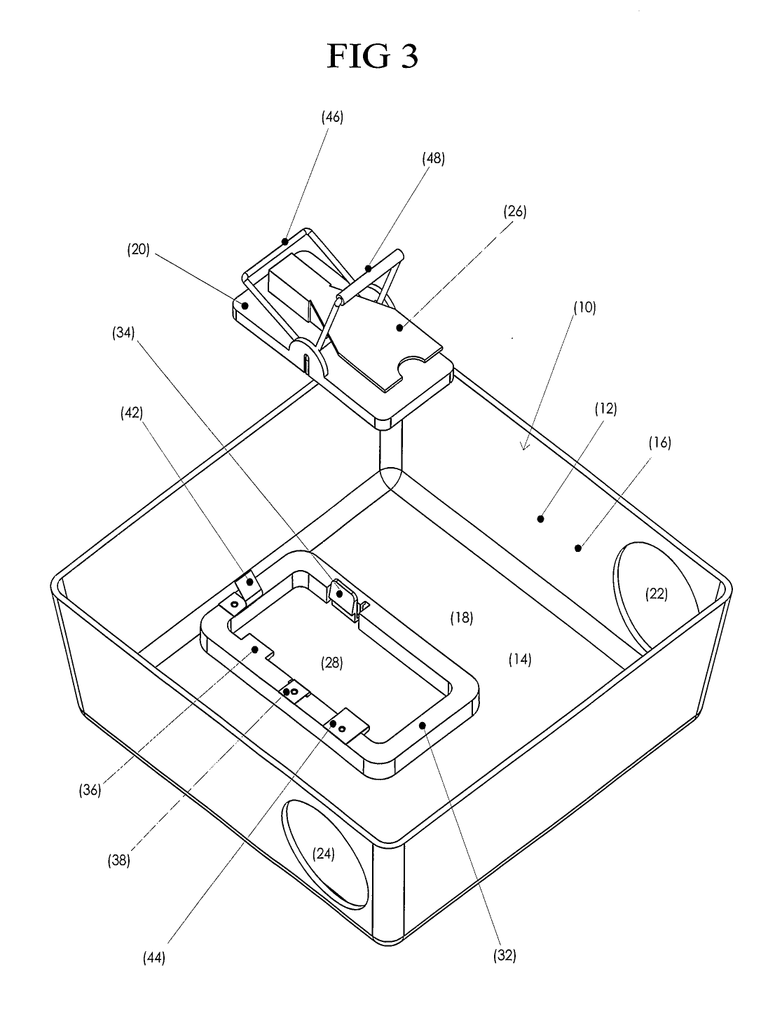

More specifically and as more clearly illustrated in conjunction with reference to FIGS. 3 to 6, the bait box (10) comprises a plastics housing (12) having a base (14), side walls (16) and a hinged top (not illustrated). The housing defines a compartment (18) which houses trap (20) together with battery pack, microprocessor and transmitter (not shown). Animals are able to enter and exit the bait box via entry and exit ports (22; 24) which are axially aligned. Two ports are preferred as rodents are more inclined to enter if there is a visible exit. The trap (20), which is a Snap E mouse trap has a pressure sensitive platform (26), a break back arm (46) and a setting arm (48) and is releaseably fitted into a trap housing (28) (FIG. 3) defined by an upstanding perimeter wall (32). The trap is retained in position by a sprung catch (34) and an overhanging ledge (36) which are on opposite sides of the perimeter wall.

The upstanding perimeter wall (32) has three contacts (38) (42) and (44) which when the trap is in various configurations form signalling circuits together with the trap. Thus:

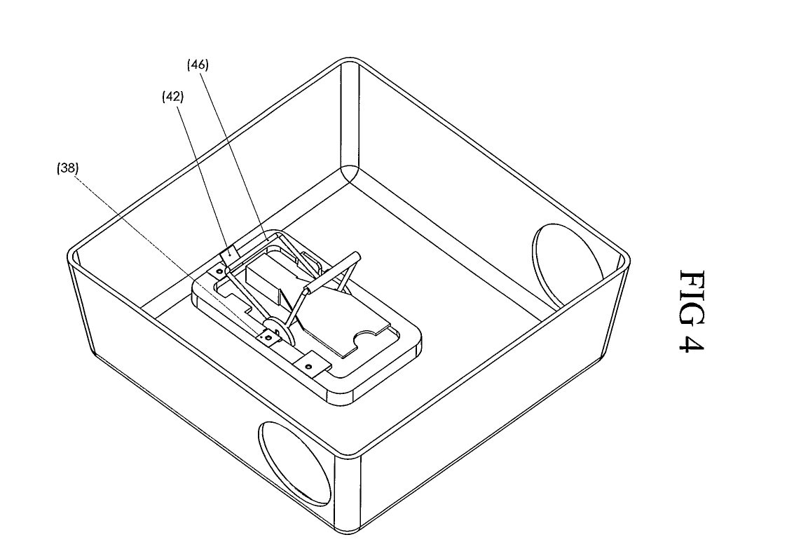

Common centre spring (38) and trap set sprang (42) are able to form a first signalling circuit via the trap's break back arm (46) when the trap is in the set position (FIG. 4);

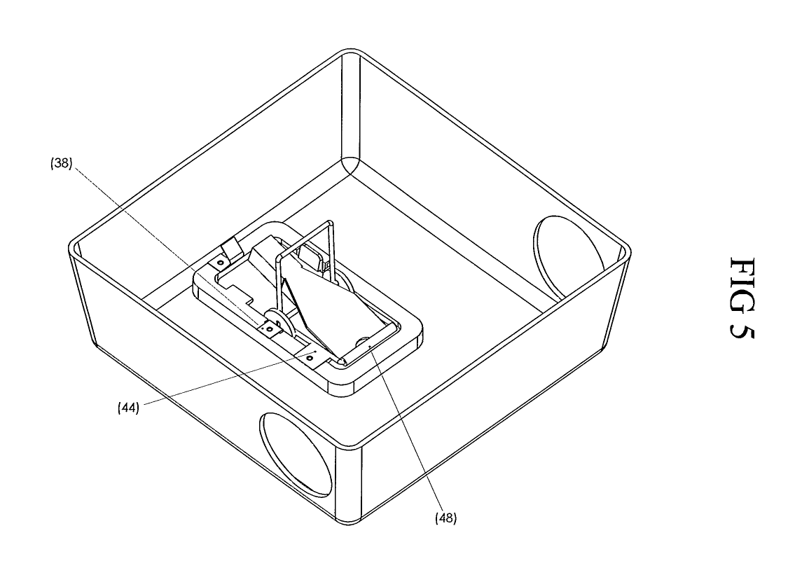

Common centre spring (38) and trap closed contact (44) are able to form a second signalling circuit via the trap's setting arm (48) when the trap is in the sprung position (FIG. 5); and

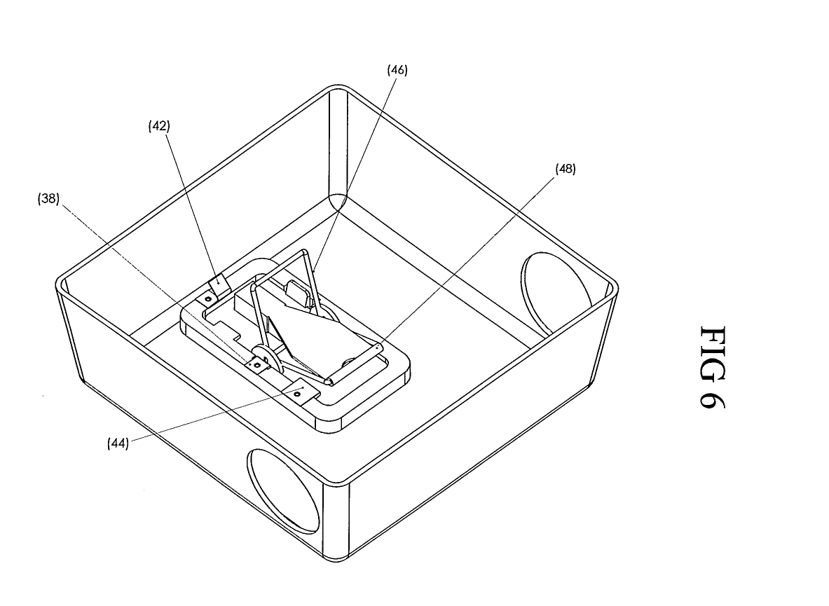

Common centre spring (38) is unable to make contact with either trap set contact (42) or trap closed contact (144) as neither the trap's break back arm (46) or trap's setting arm (48) are fully extended when an animal is caught in the trap. Consequently a broken circuit signals the trap has caught an animal (FIG. 6).

In a preferred configuration trap set spring (42) (FIG. 4) is shaped and biased to exert a slight downward pressure on the break back arm (46). This improves connectivity and assists in avoiding accidental triggering.

As can be seen in FIG. 4, in the “trap set position”, a circuit is formed between centre spring (38) and the trap set spring (42) via the trap break back arm (46). Advantageously the trap set spring contact (42) is configured to exert a downward force upon the back break arm (46). This configuration helps alleviate accidental triggering of the trap.

Having three different signals (as opposed to two) is advantageous in prioritising on site management. Additional benefits arise by programming the system in ways which improve the accuracy of the data generated.

In the system of the present invention care has been taken to control the signalling as is described below with particular reference to FIGS. 1 and 2.

Thus the remote units (110), as has been described previously, comprises a bait box (10), trap (20), battery pack (30), microprocessor (40) and transmitter (50). The microprocessor (40) is programmable via a direct link to a Non Volatile Memory (NVM).

The microprocessor is programmed to spend a majority of it's time in a dormant state so as to save battery power. It thus “wakes” for a short period of, for example, less than 1.5 seconds every, for example, 5 seconds to check the trap status.

In order to improve reporting accuracy (avoid false positives and/or negatives) the microprocessor (40) is also programmed to report only double checked signals. Accordingly, when a signal is received, the remote unit (110) waits a short period, e.g. 2 seconds before checking the next signal. If the same signal is received the signal is verified as “valid”. If not the signal is ignored. This prevents transient signals reporting false activity.

Furthermore, when a valid signal is recorded, the microprocessor is configured to stop processing signals for a given period, typically a few minutes e.g. 5 to 15 minutes. This avoids the multiple counting of “the same event”. Clearly the given period will vary for different pests.

Once a valid signal has been recorded it is transmitted as an RF (am) message containing prescribed information.

In the example given such prescribed information may include:
A remote unit number (code);
A remote unit group (a number of discrete units may be grouped by, for example locality);
A signal type (in the case of a break back trap: trap set, trap sprung or dead body); and
A check digit (allowing accurate auditing of data).

The signal is then sent repeatedly for a period sufficient to ensure it is safely received by the base station. This may vary depending on reception in the area of the trap but again, is typically, between 5 and 15 minutes.

Yet a further function of the microprocessor (40) is to, periodically, throughout the day, typically at least 2 times and more particularly at least 3 times a day and usually from 2 to 6 times a day, check that signals are being received, i.e. that the unit is operating correctly, and this is signaled to the base station (120). As above the reporting signal will include:
A remote unit number;
A remote unit group;
An OK signal; and
A check digit.

Similarly the microprocessor (66) of the base station (120) is programmable via a direct link to non volatile memory or via SMS messaging through the mobile phone network with information including:
A user access code;
A customer name;
A customer reference number;
A customer post code;
The number of remote units on the system;
A base unit zone reference;
One or a plurality of level one phone numbers; and
One or a plurality of level two phone numbers.

The level one and two numbers may be programmed to receive, by SMS message, different information. Thus, for example, level one telephone numbers may receive:
A unit start up message (which will be received when the base station is powered up);
An “all traps ok” message (which will be sent daily to confirm the system is working) or alternatively
“traps missing 1, 2, 3” message (which will indicate a if a trap has sprung, caught a mouse or lost the signal, or if a remote station is missing or not working)

On the other hand, level two telephone numbers may receive more detailed information including:
A unit start up message;
A “trap 1 sprung” message;
A “dead body trap 1” message;
An “activity message”; or
“Traps missing” daily status message.

In order to avoid duplication of messaging the system is programmed with a “check system”. Thus, when a signal is received by the AM receiver, the base station waits for a set period, anything from about 30 seconds to 5 minutes, typically about a 1 minute before checking the signal a second time. If the same signal is received after the “set period”, the base station will proceed to decode the signal and verify that it is a valid signal from the same remote station by, for example, using information from one or more of the check digit, remote unit number and remote unit zone.

If the signal is, following this check, confirmed to be valid, the base station (120) will ignore further signals from that remote station (110) for another set period, typically 5 to 30 minutes, for example, 9 minutes to avoid duplication.

If a valid signal is an activity message, the microprocessor passes instructions to the GSM module to send an SMS message to the relevant stored number(s). The message will typically include information in the form of:
A customer name;
A customer reference number;
A customer post code;
A remote unit number; and
An activity e.g. Trap Sprung, Dead Body

As with all SMS messages, the message will also contain the number of the sender (the sim card fitted in the GSM module) and the date and time of sending.

If a valid signal is an “OK” signal, the base station will store the signal with its remote station number.

Approximately once a day the system is programmed such that the base station's microprocessor (66) will interrogate the memory and pass a status message to the GSM module (68). If there is an “OK” signal present from all the remote stations on the system, the GSM module will send an OK daily status message to the relevant stored number(s). The message will be in the form of:
A customer name;
A customer reference number,
A customer post code;
A 24 hour check; and
All traps OK.

If there are one or more “OK” signals missing, the GSM module will send a “Traps Missing” daily status message to the relevant stored numbers. The message will be in the form of:
A customer name;
A customer reference number;
A customer post code;
A 24 hour check; and
Trap(s) missing—followed by a list of the numbers of missing remote stations.

In order to ensure that the base station (120) will continue to operate even if something causes the software to crash the GSM unit (68) is programmed to attempt to communicate with the microprocessor (66) on a regular basis, in the order of 30 minutes to a several hours, typically every hour. If it cannot get a response, it mill initiate a reset of the base unit. This ensures that the base unit will continue to operate even if something causes the software to crash.

In addition to the base station (120) and the remote stations (110) the system (100) may comprise one or more repeater units (130). Each repeater station is preferably a mains powered unit consisting of an AM receiver, an AM transmitter and a microprocessor. Its purpose is to extend the range of transmission between the remote units and the base units.

The system is programmed with the same “check system” described above such that the repeater units do not act upon duplicate signals.

Whilst the system has been described with reference to operation with a rodent trap the skilled person will appreciate that alternative trapping or monitoring systems could be used and that the invention is not limited to such systems. Thus, many variations in the nature and detail of signals and messages transmitted and received by the system are possible within the scope of the invention, and the remote stations may be designed and programmed to be actuated by different kinds of pest, be they rodents, insects or the like. In the case of insects, their presence in the remote station may be detected by the breaking of an infra-red or visible beam, and their entrapment, if required, may be by a glue board or the like.

1. A system (100) for monitoring and reporting upon the presence and/or activity of live objects such as rodents or other pests, comprising:
a. a plurality of remote stations (110); and
b. a base station (120);
wherein
the at least one remote station (110) comprises:
i) a sensing means (38,42,44,46) to detect the presence and/or activity of the live objects;
ii) a microprocessor (40) programmed to communicate with the sensing means;
iii) inputs linking the sensing means with the microprocessor; and
iv) a signal transmitter (50) adapted to transmit a signal to the base station;
and the base station (120) comprises:
i) a signal receiver (64);
ii) a microprocessor (66) programmed to analyze and communicate information received; and
iii) a message transmitter (68) for transmitting selected information to a cellular telephone (140) or computer.

2. The system recited in claim 1 wherein the transmitter is a GSM module and can transmit SMS text message to one or more phones.

3. The system recited in claim 1 wherein the remote stations' microprocessor (40) is programmed to spend the majority of its time in a dormant state and wakes periodically to check the station's status.

4. The system recited in claim 3 wherein the microprocessor wakes for less than 1.5 seconds every 5 seconds.

5. The system recited in claim 1 wherein the remote stations' microprocessor (40) is programmed to report only verified signals.

6. The system recited in claim 5 wherein a verified signal is one which has been received twice in a given time period.

7. The system recited in claim 6 wherein the given time period is a few seconds.

8. The system recited in claim 1 wherein the system is programmed to stop processing signals for a given time period after a verified signal has been received and or transmitted.

9. The system recited in claim 8 wherein the given time period is from 5-15 minutes.

10. The system recited in claim 1 wherein the system transmits information selected from the group consisting of:
A remote unit number;
A remote twit group;
A signal type; and
A check digit, or combination thereof.

11. The system recited in claim 1 wherein the remote stations' microprocessor (40) is programmed to repeatedly send a signal for a period of between 5 and 15 minutes to ensure it is received at the base station.

12. The system recited in claim 1 wherein the remote stations' microprocessor (40) is programmed to periodically, throughout a day, check that signals are being received and signal this to the base station.

13. The system recited in claim 12 wherein at least three checks are made in a 24 hour period.

14. The system recited in claim 13 wherein a reporting signal is generated and wherein the reporting signal includes:
A remote unit number;
A remote unit group;
An OK signal; and
A check digit.

15. The system recited in claim 1 wherein the base stations' microprocessor (66) is programmed with information selected from the group consisting of:
A user access code;
A customer name;
A customer reference number;
A customer post code;
The number of remote units on the system;
A base unit zone reference;
At least one level one phone number; and
At least one level two phone number and combinations thereof.

16. The system recited in claim 15 wherein the level one and level two phone numbers are programmed to receive different information.

17. The system recited in claim 16 wherein the level one numbers are programmed to receive activity messages and traps missing messages whereas the level two numbers are programmed to receive more detailed information on trap status.

18. The system recited in claim 1 wherein the base stations' microprocessor (66) is programmed to avoid duplication of messages.

19. The system recited in claim 18 wherein on receipt of a signal by the receiver (64), the base station waits for a first set period before re-checking the signal and only if the signal is the same will it decode it, verify it and send an activity message whilst simultaneously ignoring further signals from the remote station for a second set period.

20. The system recited in claim 19 wherein the first set period is from 30 seconds to 5 minutes and the second set period is from 5 to 30 minutes.

21. The system recited in claim 1 wherein the microprocessor is programmed to pass instructions to a GSM module to send an SMS message to selected stored numbers.

22. The system as claimed in claim 21 wherein the message includes information selected from the group consisting of:
A customer name;
A customer reference number;
A customer post code;
A 24 hour check; and
All traps OK, and combinations thereof.

23. The system recited in claim 22 wherein the SMS message further includes the sender number, a date and the time sent.

24. The system recited in claim 1 wherein the base stations' microprocessor (66) is programmed to interrogate its memory and pass a status report to the transmitter (68) for sending.

25. The system recited in claim 24 wherein the microprocessor (66) is programmed to transmit either an ok signal or a traps missing signal.

26. The system recited in claim 25 wherein he message includes information selected from the group consisting of:
A customer name;
A customer Reference Number;
A customer post code;
A 24 hour check; and
Trap(s) missing followed by a list of the numbers of missing remote units, with combinations thereof.

27. The system recited in claim 2 wherein the GSM unit is programmed to attempt to communicate with the base unit's microprocessor on a regular basis and in the event it cannot get a response it initiates a base reset.

28. A method of monitoring the presence and activity of live objects such as rodents or other pests, comprising the steps of providing a base station and at least one remote station, each remote station having signal transmitting capability, and the base station having SMS message transmitting capability; causing each remote station to transmit a signal upon detection of the presence of a monitored live object and causing the base station to receive such signal and in turn to transmit a SMS message to a cellular telephone network.

29. A bait box (10) for a break back trap (20) comprising:
a trap housing (28) having associated therewith three contacts (38,42,44) which when a trap is fitted thereto can, when linked to a microprocessor, send a signal indicating the trap is either set, sprung or contains a body.

30. The bait box recited in claim 29 comprising a center spring contact (38) which contacts a setting arm (48), and has contacts at either side thereof which contact a break back arm of the trap in respectively its set or sprung position.

31. The bait box recited in claim 30 wherein at lest one of the contacts is a trap set contact (42) and said trap set contact (42) is shaped and positioned to exert a downward force on the break back arm (46) in its set position.

32. The remote station recited in claim 29 in combination with a break back trap, power source, microprocessor and transmitter.
